(19) United States
(12) Patent Application Publication
(10) Pub. No.: US 2026/0161372 A1
(43) Pub. Date: Jun. 11, 2026

(54) METHOD FOR GENERATING CODE

(71) Applicants: ROBERT BOSCH GmbH, Stuttgart (DE); CARIAD SE, Wolfsbury (DE)

(72) Inventors: Christian Schildwaechter, Boennigheim (DE); Lukas Koenig, Grossbottwar (DE)

(21) Appl. No.: 19/414,423

(22) Filed: Dec. 10, 2025

(30) Foreign Application Priority Data
Dec. 11, 2024 (DE) 10020240211

(51) Int. Cl. G06F 8/35

(52) U.S. Cl. CPC G06F 8/35

(57) ABSTRACT

The invention relates to a method for generating code comprising:
receiving a data set comprising a plurality of driving scene data, each of which describes a driving scene,
processing each of the respective driving scene data using a first large language model in order to obtain a textual description of the respective driving scene for each driving scene,
processing the respective textual descriptions of the respective driving scenes using a second large language model in order to establish from the textual descriptions a rule set of rules which summarize the respective textual description,
creating a finite state machine describing an at least partially automated driving function based on the established rule set,
verifying the created state machine,
generating code for the at least partially automated driving function of a motor vehicle based on the finite state machine and depending on a result of the verification of the finite state machine.

The invention relates to a method for generating code for an at least partially automated driving function of a motor vehicle, a device, a computer program, and a machine-readable storage medium.

### PRIOR ART

The publication “DriveLM: Driving With Graph Visual Question Answering” by Sima et al., available at “https://arxiv.org/abs/2312.14150”, discloses the use of a large language model.

The published patent application DE 10 2022 207616 A1 discloses a computer-implemented method for verifying a software component of an automated driving function.

The published patent application EP 4 332 824 A1 discloses a system and a method for translating traffic rules into a formal logic for autonomous driving vehicles.

Patent specification U.S. Pat. No. 8,452,524 B2 discloses a method and a device for identifying traffic-relevant information.

Patent specification U.S. Pat. No. 11,132,211 B1 discloses a finite state machine.

Patent specification U.S. Pat. No. 8,948,936 B2 discloses a vehicle management system using a finite state machine.

### DISCLOSURE OF THE INVENTION

The object underlying the invention is to provide a concept for generating code for an at least partially automated driving function of a motor vehicle.

This object is achieved by means of the respective subject matter of the independent claims. Advantageous configurations of the invention are the subject matter of the respective dependent subclaims.

According to a first aspect, a method for generating code for an at least partially automated driving function of a motor vehicle is provided, comprising the following steps:

Receiving a data set comprising a plurality of driving scene data, each of which describes a driving scene,
processing each of the respective driving scene data using a first large language model in order to obtain a textual description of the respective driving scene for each driving scene,
processing each of the respective textual descriptions of the respective driving scenes using a second large language model in order to establish from the textual descriptions a rule set of rules which summarize the respective textual description,
creating a finite state machine describing an at least partially automated driving function based on the established rule set,
verifying the generated state machine,
generating code for the at least partially automated driving function of a motor vehicle based on the finite state machine and depending on a result of the verification of the finite state machine.

According to a second aspect, a device is provided which is configured to execute all the steps of the method according to the first aspect.

According to a third aspect, there is provided a computer program comprising statements which, when the computer program is executed by a computer, for example by the device according to the second aspect, cause the computer to execute a method according to the first aspect.

According to a fourth aspect, there is provided a machine-readable storage medium on which the computer program according to the third aspect is stored.

The invention is based on and includes the knowledge that the above object is achieved in that the driving scenes are processed by a first large language model to obtain textual descriptions of the driving scenes. Based on these textual descriptions, a rule set of rules summarizing the respective textual description is established using a second large language model. The finite state machine describing the at least partially automated driving function is then created from such an established rule set. A state machine created in this manner can be verified efficiently; in particular, the state machine can be checked for correctness. Depending on the verification check, the code for the at least partially automated driving function is generated from the finite state machine.

As a result, a code is available for an at least partially automated driving function that has been indirectly checked by verifying the state machine underlying this code. This contributes to the safety and integrity of the at least partially automated driving function of a motor vehicle.

Code in the meaning of the description refers to software code. Code in the meaning of the description can be, for example, native program code of a programming language.

A large language model in the meaning of the description can be abbreviated to LLM. The phrase “large language mode” can also be translated as “large linguistic model”. An LLM is a language model that is characterized by its ability to generate text. It is a computational linguistic probability model that has learnt statistical word and sentence sequence relationships from a plurality of text documents through a computationally intensive training process. In a broader sense, such language models are in particular artificial neural networks and, for example, can therefore be trained a priori, either through self-supervised learning or through semi-supervised learning methods.

For example, the first large language model is identical to the second large language model. For example, the first large language model is different from the second large language model. For example, it is provided that for processing the respective driving scene data, different first large language models are used in each case. For example, it is provided that for processing the respective driving scene data, the same first large language model is used.

For example, it is provided that no code is generated, i.e. that generating code for the at least partially automated driving function of a motor vehicle is omitted if the result of the verification of the finite state machine indicates that one or more errors have occurred, i.e. that the finite state machine has one or more errors, and/or if a check for correctness of the finite state machine as part of the verification has revealed that the finite state machine is not correct or does not function correctly. Correct in this context means in particular that the finite state machine does not function correctly within the required specifications.

In one embodiment of the method, it is provided that the second large language model is instructed to summarize, as summary rules, the respective textual descriptions as a conditional statement so that the established rule set comprises conditional statements as rules.

This results, for example, in the technical advantage that particularly suitable rules are given, based on which the finite state machine can be created particularly efficiently.

A conditional statement in the meaning of a description is, for example, an if-then statement or an if-then-else statement. Thus, the conditional statement can be an if-then statement or an if-then-else statement.

In one embodiment of the method, the first large language model is instructed to describe what is happening in the respective driving scene and, in particular, why, so that the respective textual description indicates what is happening in the respective driving scene and, in particular, why.

This results in the technical advantage that, for example, the respective textual description contains particularly meaningful information on the base of which the rules are to be established.

In one embodiment of the method, it is provided that a formalization is performed according to which states and state transitions for a finite state machine are derived from the established rule set, wherein the finite state machine is created based on the derived states and state transitions.

According to this embodiment, it is thus provided that the finite state machine is created by performing a formalization according to which the established rule set is transferred into a finite state machine by deriving states and state transitions for the finite state machine from the established rule set.

This results, for example, in the technical advantage that the finite state machine can be efficiently created.

In one embodiment of the method, it is provided that the verifying comprises visualizing the finite state machine in human understandable form for verification by a human, and that an input is captured which represents a result of the human verification, wherein the code is generated depending on the captured input.

For example, this results in the technical advantage that a human can efficiently verify the finite state machine.

In one embodiment of the method, it is provided that the verifying comprises that model checking is used to verify the finite state machine.

This has the technical advantage, for example, that the verification can be carried out efficiently.

In particular, model checking is a method for the fully automatic verification of a system description, in this case the state of the state machine, against a specification. For example, a “Symbolic Model Verifier”, which can also be abbreviated to “SMV”, can be used to verify the finite state machine.

A finite state machine in the meaning of the description can also be referred to as a finite automaton or a finite state automation. In English, the term “Final State Machine (FSM)” is used for this. A state machine in the sense of the description comprises or consists of states, state transitions and actions. A state machine in the sense of the description is therefore in particular a model of a behavior, in the present case a behavior of the at least partially automated driving function.

The method according to the first aspect is, for example, a computer-implemented method.

For example, the device has a programmable configuration to execute the computer program.

The device is a computer, for example.

Method features result analogously from corresponding device features and vice versa.

Technical functionalities and technical features of the method result analogously from corresponding technical functionalities of the device and technical features of the device and vice versa.

The method is carried out by means of the device, for example.

The embodiments and exemplary embodiments described herein can be combined with each other in any way, even if this is not explicitly described.

Driving scene data within the meaning of the description includes, for example, one or more of the following data: video data, radar data, LiDAR data, ultrasonic data and infrared data.

A driving scene within the meaning of the description is, in particular, a scene from road traffic, thus describing, for example, a driving situation in road traffic.

The phrase “at least partially automated” comprises the following phrases: partially automated, highly automated, fully automated, and autonomous.

Partially automated corresponds to a degree of automation 2 according to the definition of the Bundesanstalt für Straßenwesen (BASt) (Federal Highway and Transport Research Institute). Highly automated corresponds to a degree of automation 3 as defined by the BASt. Fully automated corresponds to a degree of automation 4 as defined by BASt. Autonomous corresponds to a degree of automation 5 according to SAE (J3016), wherein SAE stands for “Society of Automotive Engineers”.

The invention is explained in more detail below based on preferred exemplary embodiments. In the figures:

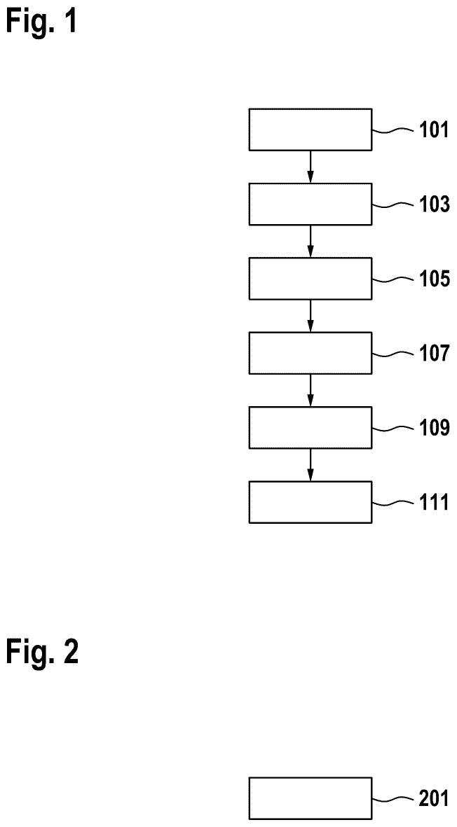

FIG. 1 shows a flowchart of a method according to the first aspect,

FIG. 2 shows a device according to the second aspect,

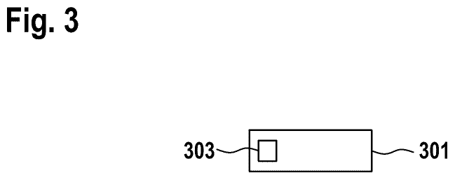

FIG. 3 shows a machine-readable storage medium according to the fourth aspect, and

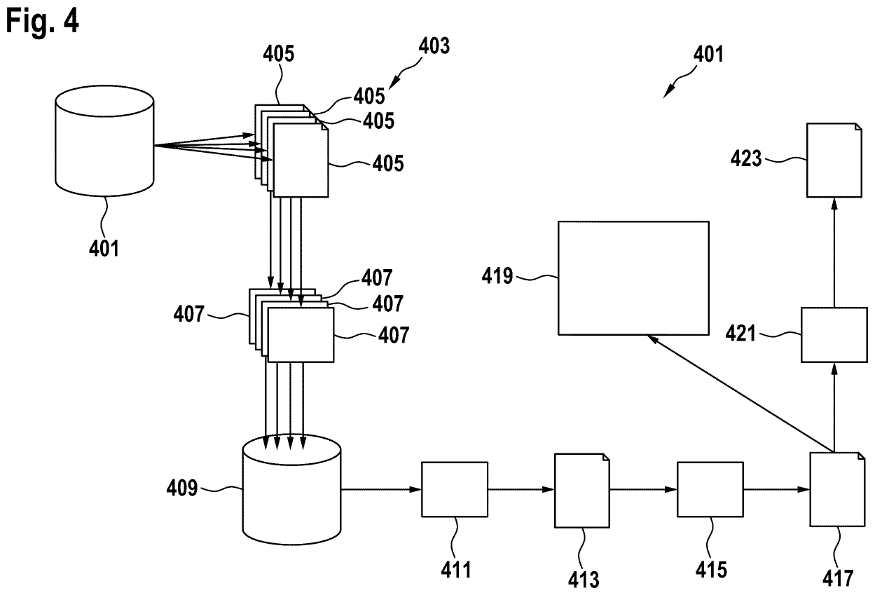

FIG. 4 shows a block diagram.

FIG. 1 shows a flowchart of a method for generating code for an at least partially automated driving function of a motor vehicle, comprising the following steps:
receiving 101 a data set comprising a plurality of driving scene data, each describing a driving scene,
processing 103 each of the respective driving scene data using a first large language model to obtain a textual description of the respective driving scene for each driving scene,
processing 105 the respective textual descriptions of the respective driving scenes using a second large language model to establish from the textual descriptions a rule set of rules which summarize the respective textual description,
creating 107 a finite state machine describing an at least partially automated driving function, based on the established rule set,
verifying 109 the created state machine,
generating 111 code for the at least partially automated driving function of a motor vehicle, based on the finite state machine and depending on a result of the verification of the finite state machine.

FIG. 2 shows a device 201 that is configured to execute all steps of the method according to the first aspect.

FIG. 3 shows a machine-readable storage medium 301 on which a computer program 303 is stored. The computer program 303 comprises instructions which, when executed by a computer, cause the computer to execute a method according to the first aspect.

FIG. 4 shows a block diagram 401 that explains the concept described herein by way of example.

A data set 401 is received, which comprises a plurality 403 of driving scene data 405, each of which describes a driving scene. The driving scene data 405 is, for example, or comprises, for example, video data.

Using a respective first large language model 407, the respective driving scene data 405 is processed to obtain a textual description of the respective driving scene for each driving scene. As a result of this processing, a further data set 409 is thus provided, which comprises the textual descriptions of the driving scenes.

Using a second large language model 411, the textual descriptions according to the further data set 409 are processed in order to establish from the textual descriptions a rule set 413 of rules which summarize the respective textual description.

According to a function block 415, states and state transitions for a finite state machine are derived from the established rule set 413 in order to create such a machine based on the derived information: the created finite state machine is marked with reference sign 417 in FIG. 4. The finite state machine 417 describes or represents an at least partially automated driving function of a motor vehicle.

The finite state machine 417 is verified according to a function block 419. For example, the verifying 419 comprises a formal white-box verification.

The term “white box verification” means that the item to be tested, for example code, in the present case the state machine, is known and is checked directly for errors (here automatically; alternatively and/or additionally, it can also be checked semi-automatically and/or manually). This term is to be seen in contrast to “black box verification” when the code is not considered directly, but only its execution, for example in classical testing.

Verification 419 comprises, for example, verifying the finite state machine 417 by means of model checking.

Depending on the verification 419, code 423 for the at least partially automated driving function of a motor vehicle is created from the finite state machine 417 by a code generator 421, which can be implemented in software and/or hardware, for example. For example, native program code is created.

An input to the respective first large language model 407 can comprise, for example, the following: “Explain in as much detail as possible what is happening in the driving scene and why.” For example, the input can comprise the following: “Explain in as much detail as possible what is happening in the video and why.”

An input to the second large language model 411 can comprise, for example, the following: “Summarize the descriptions as ‘if X, then Y’ rules.” Descriptions here refer to textual descriptions.
The concept described here thus advantageously allows scalable automated generation of rule-based and thus at least partially automated driving functions that are comprehensible for humans and through formal verification.

For example, a data set of the most diverse traffic situations possible from, for example, fleet measurements and/or simulations and/or Internet videos is used as input. For example, this data set is processed by generative artificial intelligence, such as GBT, and/or LLM, and/or by foundation models, in the sense of a textual description, such as, for example as follows: “If front vehicle performs acceleration x, EGO vehicle performs acceleration y”.

A result of this processing can be further processed into rules of a finite state machine as part of post-processing. For example, a rule-based code of the finite state machine is therefore created as output.

A processing chain, as it can be implemented in the concept described here, can look like and comprise, respectively, the following, for example:

Driving situation data set—generative artificial intelligence→textual description of the driving modes—FSM extraction→rule-based driving function.

FSMs can be advantageously visualized by tools in a human-understandable form and checked for correctness using formal methods.

In this manner, code for an at least partially automated driving function of a motor vehicle, which has been efficiently indirectly tested or verified, can be efficiently generated. Indirectly here means that the finite state machine on which the generated code is based has been verified in accordance with the concept described here or has been verified using the tools and possibilities described here.

Usually, rule-based driving functions have typically been hand-written so far, and covering all possible cases can be difficult. On the other hand, driving functions in machine learning approaches are mapped by deep neural networks that are largely considered as black boxes, which can lead to corresponding problems in explainability and verifiability. This means that code created by such deep neural networks is difficult to verify, and/or the deep neural network underlying this code is difficult to verify, as it is usually a black box.

The concept described here, on the other hand, makes it possible to create code for an at least partially automated driving function of a motor vehicle in an explainable and verifiable manner, which means a gain in safety for the at least partially automated driving function of the motor vehicle.

1. A method for generating code for an at least partially automated driving function of a motor vehicle, comprising the following steps:
receiving a data set comprising a plurality of driving scene data, each of which describes a driving scene,
processing each of the respective driving scene data using a first large language model in order to obtain a textual description of the respective driving scene for each driving scene,
processing the respective textual descriptions of the respective driving scenes using a second large language model in order to establish from the textual descriptions a rule set of rules which summarize the respective textual description,
creating a finite state machine describing an at least partially automated driving function based on the established rule set,
verifying the created state machine,
generating code for the at least partially automated driving function of a motor vehicle based on the finite state machine and depending on a result of the verification of the finite state machine.

2. The method according to claim 1, wherein the second large language model is instructed to summarize, as summary rules, the respective textual descriptions as conditional statement so that the established rule set comprises conditional statements as rules.

3. The method according to claim 1, wherein the first large language model is instructed to describe what happens in the respective driving scene so that the respective textual description indicates what is happening in the respective driving scene.

4. The method according to claim 1, wherein a formalization is performed according to which states and state transitions for a finite state machine are derived from the established rule set, wherein the finite state machine is created based on the derived states and state transitions.

5. The method according to claim 1, wherein the verifying comprises that the finite state machine is visualized in human-understandable form for verification by a human, and that an input representing a result of the human verification is captured, wherein the code is generated in dependence on the captured input.

6. The method according to claim 1, wherein the verifying comprises that model checking is used to verify the finite state machine.

7. A device comprising:
a computer storing a computer program that when executed by the computer cause the computer to:
receive a data set comprising a plurality of driving scene data, each of which describes a driving scene,
process each of the respective driving scene data using a first large language model in order to obtain a textual description of the respective driving scene for each driving scene,
process the respective textual descriptions of the respective driving scenes using a second large language model in order to establish from the textual descriptions a rule set of rules which summarize the respective textual description,
create a finite state machine describing an at least partially automated driving function based on the established rule set,
verify the created state machine,
generate code for the at least partially automated driving function of a motor vehicle based on the finite state machine and depending on a result of the verification of the finite state machine.

8. (canceled)

9. (canceled)

10. The method according to claim 1 wherein the first large language model is instructed to describe why one or more activities happen in the respective driving scene, so that the respective textual description indicates why the one or more activities are happening in the respective driving scene.

11. A non-transitory computer-readable medium storing a computer program, which when is executed by a computer, causes the computer to:
receive a data set comprising a plurality of driving scene data, each of which describes a driving scene,
process each of the respective driving scene data using a first large language model in order to obtain a textual description of the respective driving scene for each driving scene,
process the respective textual descriptions of the respective driving scenes using a second large language model in order to establish from the textual descriptions a rule set of rules which summarize the respective textual description,
create a finite state machine describing an at least partially automated driving function based on the established rule set,
verify the created state machine,
generate code for the at least partially automated driving function of a motor vehicle based on the finite state machine and depending on a result of the verification of the finite state machine.
